(19) United States
(12) Patent Application Publication
(10) Pub. No.: US 2018/0231632 A1
(43) Pub. Date: Aug. 16, 2018

(54) MULTI-RECEIVER GEOLOCATION USING DIFFERENTIAL GPS

(71) Applicant: Raytheon Company, Waltham, MA (US)

(72) Inventors: Stanley I. Tsunoda, Waltham, MA (US); Paul H. Grobert, Waltham, MA (US); Phuoc T. Ho, Waltham, MA (US)

(73) Assignee: Raytheon Company, Waltham, MA (US)

(21) Appl. No.: 15/433,479

(22) Filed: Feb. 15, 2017

(51) Int. Cl. G01S 5/02; G01S 19/41; G01S 5/04

(52) U.S. Cl. CPC G01S 5/0263; G01S 5/04; G01S 19/41

(57) ABSTRACT

A system for multi-ship geolocation of a signal emitter of interest uses differential GPS (DGPS) to determine the relative positions of two or more receivers in order to determine baseline vectors between them. The geolocation of the signal emitter is then determined as a function of the baseline vectors. The use of DGPS allows for more efficient and useful geometries between the receivers as two receivers can both be in a mainlobe of an emitted signal and still provide increased geolocation accuracy.

### GOVERNMENT RIGHTS

N/A

### FIELD OF THE INVENTION

The disclosure relates to multi-ship, i.e., multi-receiver, geolocation of a transmitting entity.

### BACKGROUND

In some approaches to multi-ship geolocation (MSG) of the transmitting entity (referred to as the “emitter” or the “target”), long distances (baseline vectors) between the aircraft are needed in order to obtain sufficiently accurate angle geolocation. Moreover, multiple baseline vectors are often required in order to triangulate the directions to the emitter from the baseline vectors. The angles subtended by these long baseline vectors, however, are much larger than a typical emitter beamwidth. Thus, one or more aircraft will be in the emitter signal sidelobes. As a result, the probability of detection and the accuracy of Time of Arrival (TOA) and Time Difference of Arrival (TDOA) measurements are degraded. In addition, the necessity of long distances between the aircraft requires inefficient and inconvenient aircraft geometries in order to locate the emitter.

What is needed is a more effective approach to implementing multi-ship geolocation.

### SUMMARY

According to one aspect of the disclosure, a method of determining a geolocation of a signal emitter comprises detecting, at a first receiver, an emitter signal from the signal emitter; the first receiver generating first receiver data corresponding to the detected emitter signal; the first receiver generating first position data corresponding to differential GPS (DGPS) signals detected at the first receiver; receiving, at the first receiver, from a second receiver, second receiver data corresponding to the emitter signal detected at the second receiver and second position data comprising DGPS data corresponding to the second receiver; and the first receiver determining the geolocation of the signal emitter as a function of the first and second receiver data and the first and second position data.

In one implementation, the first receiver transmits the first receiver data and the first position data to the second receiver and the second receiver also determines the geolocation of the signal emitter as a function of the first and second receiver data and the first and second position data.

In another aspect, a method of determining a geolocation of a transmitter of a signal comprises: detecting the transmitted signal at a first location and generating first detection data corresponding to the transmitted signal detected at the first location; generating first position data as a function of DGPS signals detected at the first location; detecting the transmitted signal at a second location and generating second detection data corresponding to the transmitted signal detected at the second location; generating second position data as a function of DGPS signals detected at the second location; and determining the geolocation of the transmitter as a function of the first and second detection data and the first and second position data.

In another aspect, an apparatus for determining the geolocation of a signal emitter comprises: a DGPS receiver configured to generate first position data corresponding to detected DGPS signals; a datalink transceiver configured to receive data from other devices on a network; a radar warning receiver (RWR) configured to generate first receiver data as a function of an emitter signal detected from the signal emitter; and a controller, coupled to the DGPS receiver, the datalink transceiver and the RWR. The controller is configured to determine the geolocation of the signal emitter as a function of: the first position data; the first receiver data; second position data corresponding to DGPS signals detected at, and received from, another device on the network; and second receiver data generated by, and received from, the other device on the network, the second receiver data generated as a function of the emitter signal from the signal emitter detected at the other device on the network.

### BRIEF DESCRIPTION OF THE DRAWINGS

Various aspects of at least one implementation of the disclosure are discussed below with reference to the accompanying Figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, not every component may be labeled in every drawing. The Figures are provided for the purposes of illustration and explanation to aid in understanding the teachings of the disclosure. In the Figures:

FIG. 1 is a representation of an implementation of an aspect of the disclosure;

FIG. 2 is a functional block diagram of a system in accordance with an implementation of an aspect of the disclosure;

FIG. 3 is a flowchart of a method in accordance with an implementation of an aspect of the disclosure;

FIGS. 4A-4C represent an implementation of an aspect of the disclosure; and

FIG. 5 represents an example of a known approach to multiship geolocation.

### DETAILED DESCRIPTION

In the following detailed description, numerous specific details are set forth in order to provide a thorough understanding of the implementations of the disclosure. It will be understood by those of ordinary skill in the art that these implementations of the disclosure may be practiced without some of these specific details. In other instances, well-known methods, procedures, components and structures may not have been described in detail so as not to obscure the implementations of the disclosure.

Prior to explaining at least one implementation of the disclosure in detail, it is to be understood that its application is not limited to the details of construction and the arrangement of the components set forth in the following description or illustrated in the drawings. Also, it is to be understood that the phraseology and terminology employed herein are for the purpose of description only and should not be regarded as limiting.

It is appreciated that certain features, which are, for clarity, described in the context of separate implementations, may also be provided in combination in a single implementation. Conversely, various features, which are, for brevity, described in the context of a single implementation, may also be provided separately or in any suitable sub-combination.

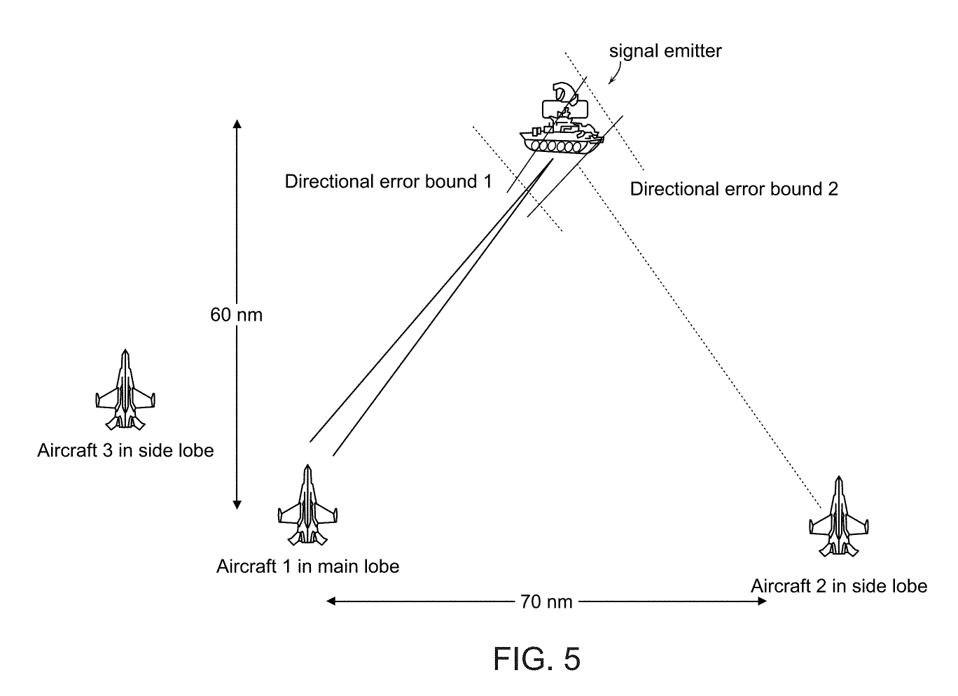

A shortcoming associated with a known approach to multi-ship geolocation will now be discussed with reference to FIG. 5. As known, direction measurements are each made from two aircraft, e.g., aircraft 1 and aircraft 2, using a known single ship direction finding technique. Each of these direction measurements, however, has a large error associated with it that can be expressed as Directional error bound 1 and Directional error bound 2. The emitter is geolocated by triangulating the two direction measurements, however, because the geolocation determination relies on triangulation, the separation between the two aircraft needs to be comparable to the range to the emitter. As shown, for example, aircraft 1 and aircraft 2 are 60 nautical miles from the emitter and are 70 nautical miles apart from one another. The required separation angle, therefore, is large compared to typical emitter beamwidths and, as a result, the two aircraft are not both in the main beam of the emitter signal. For example, as shown in FIG. 5, aircraft 1 is in the emitter signal main lobe while aircraft 2 is in the emitter signal sidelobe as, for example, a typical 2° emitter signal has a beamwidth at a distance of 60 nautical miles of nearly four (4) km (1 km≈0.54 nautical miles (nm); 1 nm≈1.85 km).

Having one airplane in the main lobe and the other in the side lobe of the emitter signal can cause potential problems in the detection of the emitter and will cause the directional error measured by aircraft 2 to be larger. One approach to reducing the error is to make the direction measurement using two aircraft to make a single TDOA measurement. Thus, for example, a third aircraft, e.g., aircraft 3 in FIG. 5, together with aircraft 1, performs a TDOA direction measurement that would reduce directional error bound 1. Of course, the directional measurement from aircraft 2 would still be needed. In both of these cases, however, large separations between the aircraft are still needed, one or more aircraft are in an emitter signal sidelobe and the aircraft need to make inefficient flight trajectories in order to perform the geolocation measurement.

One way to reduce the size and number of the baseline vectors is to measure the Frequency Difference of Arrival (FDOA) of the emitter signal. This not only reduces the baseline vector size, but also enables geolocation from a single baseline vector. Thus, only two aircraft are required. In order to make use of FDOA measurements, however, one requires an accurate measurement of the relative velocity between the two aircraft.

Advantageously, in implementations of the present disclosure, a shorter baseline vector can be used when DGPS techniques are employed to accurately determine the baseline vector position, orientation and velocity. Using DGPS techniques to measure the TDOA/FDOA baseline vector, two aircraft, for example, can be in the main beam and still form a sufficiently long and effective baseline vector.

As mentioned above, for a 2° emitter signal, the beamwidth at a distance of 60 nautical miles is nearly four (4) km. A two (2) km multi-ship baseline vector would correspond to an increase over the single ship baseline vector of a typical large aircraft, e.g., a KC-46, by a factor of 50. This would correspond to an improvement in the TDOA angle random error by a factor of 50 over typical single ship geolocation performance. For multi-ship geolocation, per the present disclosure, because the velocity difference between the two aircraft may be very large, and because the baseline vector position and velocity are precisely known with DGPS, the magnitude of the FDOA signal may also be much larger than the typical single ship value of FDOA. This large improvement in TDOA and FDOA accuracy results in extremely accurate geolocation.

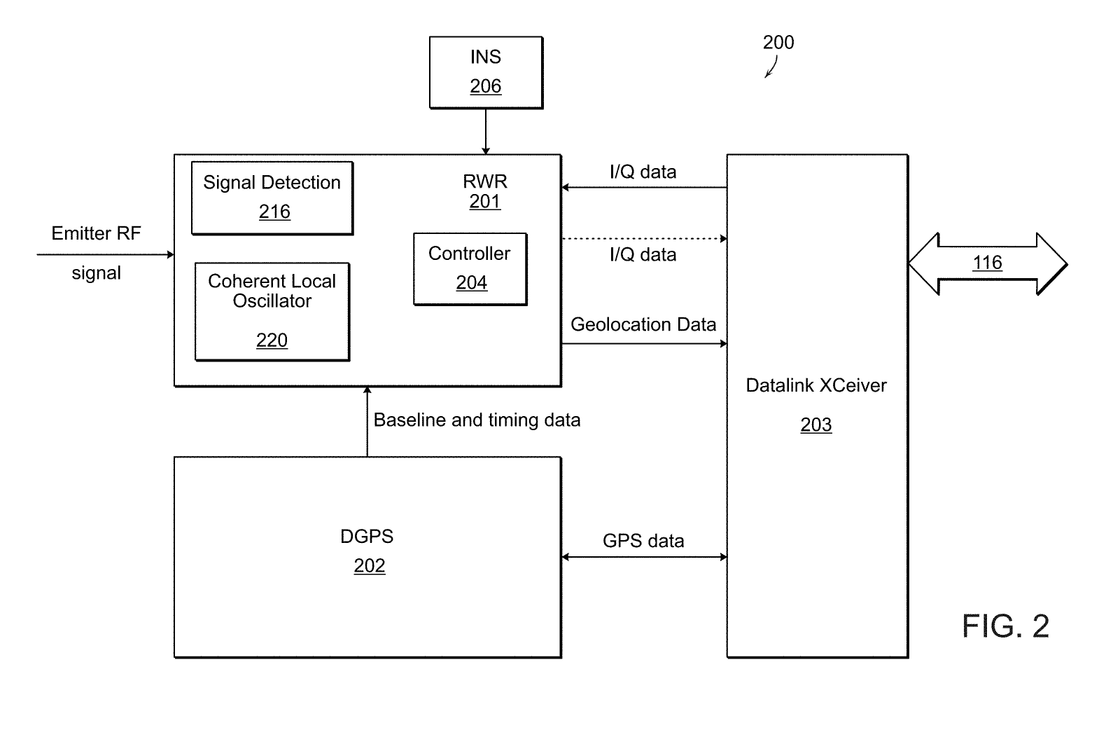

In one aspect of the present disclosure, each aircraft includes a locating system 200, referring to FIG. 2, that includes a Radar Warning Receiver (RWR) 201, a DGPS receiver 202, a Datalink Transceiver 203 and an Inertial Navigation System (INS) 206. The RWR 201 detects the emitter RF signal and digitizes a frequency downconverted baseband signal. The DGPS receiver 202 measures the baseline vector position and velocities. The datalink transceiver 203 communicates over a datalink 116 established with another aircraft in order to communicate and coordinate with one another in determining the location of a signal emitter. The RWR 201 includes a controller 204, a TDOA/FDOA signal detector/processor 216 and a coherent local oscillator 220.

The RWR 201 may be an AN/ALR-69A(V) Radar Warning Receiver and the DGPS receiver 202 may be a Precision Electronic Warfare (PREW-T) DGPS receiver both developed by the Raytheon Company, Waltham, Mass. The local oscillator 220 is coherent with the other local oscillators in the other RWRs 201 provided in, for example, other aircraft, and may be a compact atomic clock or may be a stable crystal oscillator that is disciplined by DGPS timing data. The atomic clock may also be disciplined by DGPS timing data for additional stability. The atomic clock may be any one of a number of commercially available clocks with adequate frequency stability to support high FDOA SNR requirements, e.g., a Spectratime LPFRS rubidium oscillator from Spectratime, Austin, Tex.

The emitter signal detection and digitization in the RWR 201 needs to be precisely time synchronized with the other RWRs 201 and this is also accomplished with the timing synch signal from the DGPS receiver 202. Each DGPS 202 shares data, with the other DGPS receivers 202 in the other aircraft and one or more RWRs 201 shares In-phase/Quadrature (I/Q) data with one or more other RWRs 201 as well. In addition, in order to obtain accurate FDOA measurements, the local oscillator 220 within each RWR 201, which is used to downconvert the emitter RF signal, must be coherent with those of the other RWRs, as described above.

The datalink transceiver 203 may be one that supports Tactical Targeting Network Technology (TTNT), a secure, robust and low latency IP-based waveform that delivers an ad hoc mesh network at up to 2 Mbps per terminal.

The controller 204 may be a known general purpose computer with required memory, storage, I/O, etc., as known to those of skill in the art, and is programmed to interface with the other components in accordance with the teachings of this disclosure. The TDOA/FDOA signal detector/processor 216 functions may be incorporated into the controller 204 or it may be a standalone special purpose device.

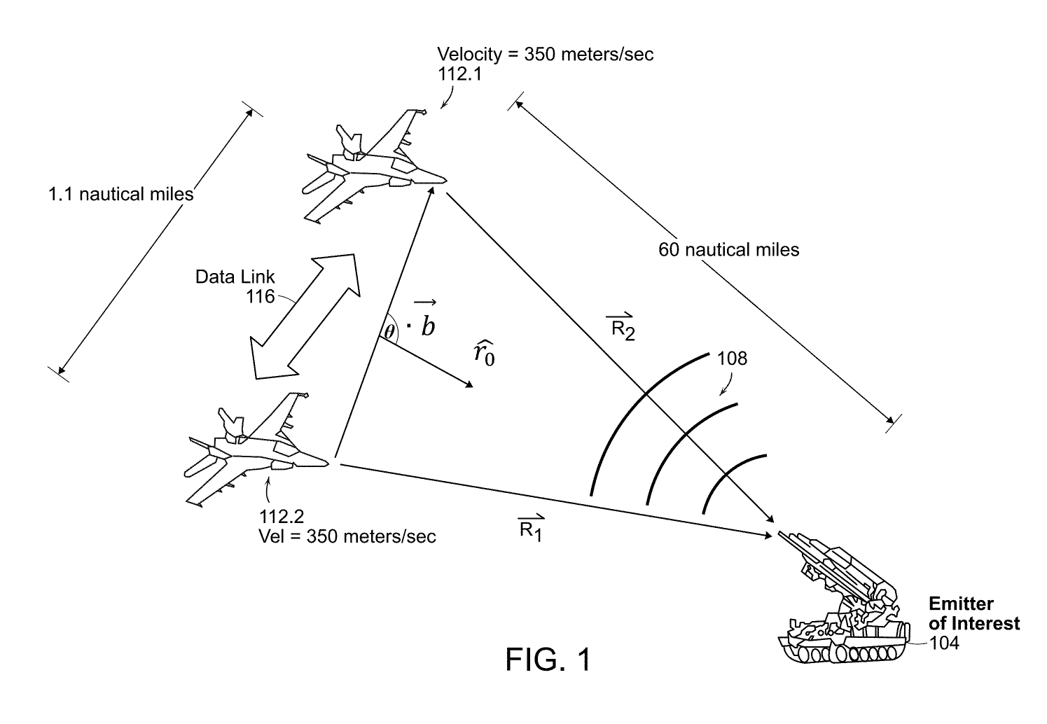

An explanation that illustrates the aircraft configuration and operation of one implementation of the disclosure will now be described with respect to FIG. 1. As shown, a signal emitter of interest 104 is emitting a signal 108, for example, a radar signal. Two aircraft 112.1, 112.2 are flying in formation and have a baseline vector b defined between them.

The difference in arrival times of a pulse, i.e., the emitter signal, received at the RWRs 201 of the two aircraft shown in FIG. 1 is given by:

$$τ = \frac{1}{c} \vert \vec{{R}_{2}} - \vec{{R}_{1}} \vert = \frac{1}{c} \vert ( \vec{{R}_{1}} - \vec{b} ) - \vec{{R}_{1}} \vert$$

For |\vec{b}|«\vec{R}≈\vec{R}₁≈\vec{R}₂ this becomes the TDOA equation:

$$τ = - \frac{1}{c} \vec{b} \cdot$$

where [symbol] is the line of sight unit vector and c is the speed of light. The time derivative of the TDOA equation is taken to obtain the FDOA equation:

$$c \frac{d τ}{dt} = - \frac{d \vec{b}}{dt} \cdot - \vec{b} \cdot$$

The RWRs 201 will measure the TDOA, τ, and the time rate of change of TDOA,

$$\frac{d τ}{dt} ,$$

from the RF signal measured at each aircraft. The baseline vector, \vec{b}, and the baseline velocity vector,

$$\frac{d \vec{b}}{dt} ,$$

are determined by differential GPS measurements. The DGPS receiver 202 at each aircraft will make carrier phase type measurements using a common set of satellites in the constellation. Together with each aircraft's inertial navigation system (INS) data, a precise determination of \vec{b} and

$$\frac{d \vec{b}}{dt}$$

can be made.

It should be noted that the pair of DGPS receivers 202 are not making absolute position measurements of each respective aircraft, but rather are making differential measurements of the relative position and velocity of one aircraft with respect to the other. Once the above quantities are measured by the respective RWR 201 and the DGPS receiver 202, one or both of the RWRs 201 solves the above equations for the line of sight vector, \hat{r}₀. Projecting the line of sight vector to the ground yields the geolocation of the emitter of interest 104. The detected emitter signals and the baseline vector motion are each time tagged separately. They are brought together in the RWR and the time tags are matched up to perform the geolocation processing.

The datalink transceivers 203 send emitter signal information over the high speed datalink 116 between the aircraft in order for the RWR 201 to measure the TDOA and FDOA of the emitter signal. In addition, DGPS information is transferred to determine the baseline vector position and velocities.

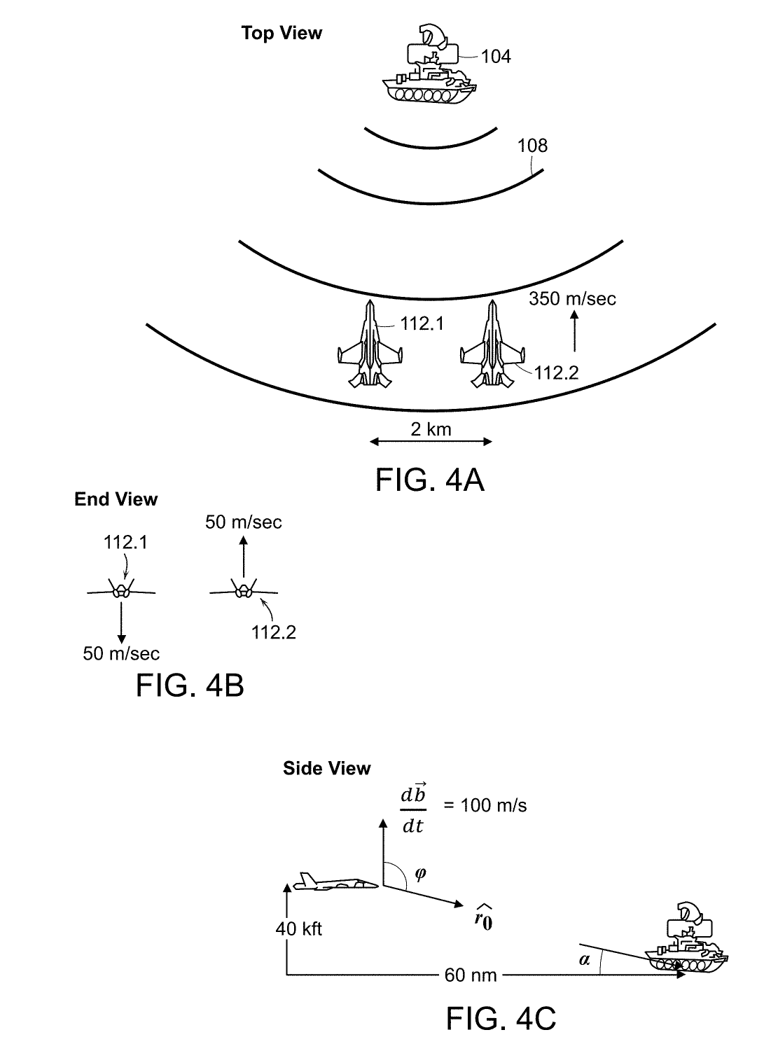

The errors associated with this technique can be illustrated in the following way. For explanatory purposes, it is assumed that the two aircraft are approaching the emitter at a relatively high speed, e.g., 350 meters/sec, as shown in FIG. 4A and execute vertical motions, e.g., climb and descend at 50 meters/second, as shown in FIG. 4B. If the differentials of the TDOA equation are taken, then:

$$d τ = - \frac{1}{c} db cos θ - \frac{1}{c} b sin θ d θ$$

where θ is the angle between the line of sight vector and the baseline vector, \vec{b} as shown in FIG. 1. The error, dθ, in this geometry is also the azimuthal error of the geolocation. Solving for dθ:

$$d θ = \frac{- c d π}{b sin θ} - \frac{db cot θ}{b}$$

defines the dependence of the azimuthal error on the TDOA measurement error, dr and the baseline vector positional error, db. This analysis is provided simply to point out the physical origins of the error.

The actual error is best determined with a monte carlo simulation of the problem, the results of which have been found to be consistent with the expected errors that are estimated taking differentials. Both terms in the above expression for dθ are very small. The TDOA measurement error depends on the timing errors in the RWRs 201. These errors typically dominate the timing error associated with the DGPS synchronization. One advantage of multi-ship TDOA is that the value of b in both denominators is so much larger than either the timing error (cdτ) or the positional error measurement (db) obtained with DGPS that the resultant azimuthal error is very small.

Taking differentials of the FDOA equation results in:

$$c d ( \frac{d τ}{dt} ) = - d ( \frac{db}{dt} ) cos ϕ - \frac{db}{dt} sin ϕ d ϕ$$

where φ is the angle between the baseline velocity vector and the line of sight vector as shown in FIG. 4C. The error, dφ, in this geometry is also the error in the elevation angle to the emitter. Solving for dφ results in:

$$d ϕ = - \frac{c d ( \frac{d τ}{dt} )}{\frac{db}{dt} sin ϕ} - \frac{d ( \frac{db}{dt} ) cot ϕ}{\frac{db}{dt}} .$$

Both terms in this expression are small where the first term is the error contribution due to the FDOA measurement error. That error depends on the coherence of the independent clocks in the RWRs 201. This error can be made sufficiently small with DGPS disciplined crystal oscillators or with compact atomic clocks. The large value of the baseline vector velocity due to the difference of the vertical velocities of the aircraft keeps this contribution small. The second term is the error contribution due to the baseline vector velocity measurement error. It is because of this term that the differential GPS scheme is used. The baseline vector velocity errors obtainable with the DGPS technique drive down this contribution to quite small values. Again, the large velocity difference between the aircraft in the denominator helps minimize the elevation angle error.

In the above example, which is in accordance with an implementation of the disclosure, the two aircraft 112.1, 112.2 may be flying toward the signal emitter 104 at 350 m/sec and separated from one another by 2 km, i.e., the baseline vector, as shown in FIG. 4A. If the first aircraft 112.1 descends at a first velocity, e.g., 50 m/sec, which is significantly less than the forward velocity, and the second aircraft climbs at the same velocity, as shown in FIG. 4B, then the detected signals from the emitter 104 can be processed to determine the location. In another implementation, a trajectory for each aircraft would be a spiral orbit around the baseline vector midpoint.

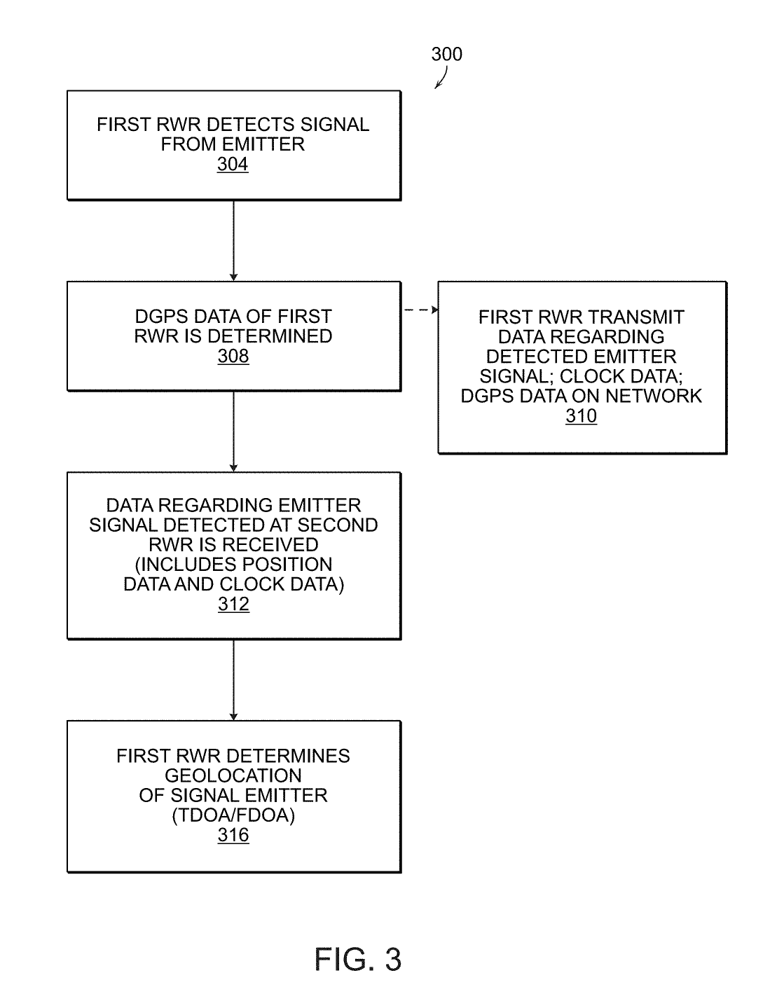

An example of a method 300, in accordance with an implementation of the disclosure, of geolocating an emitter of interest 104 by two aircraft 112.1, 112.2, will now be described with reference to FIG. 3. At step 304, a first RWR 201 in the first aircraft 112.1 detects a signal from the emitter 104. Position data based on the DGPS signals detected by a first DGPS receiver 202 of the first aircraft 112.1 is generated at step 308. The first RWR 201 receives, via a first datalink transceiver 203, data regarding the emitter signal detected at a second RWR 201 of the second aircraft 112.2, step 312. The received data includes position data based on the DGPS signals received by a second DGPS receiver 202 of the second aircraft 112.2 along with clock signal data. The geolocation of the signal emitter 104 is then determined by the first RWR 201 of the first aircraft 112.1 as a function of the data generated in steps 304 and 308 and received from the second aircraft 112.2 at step 312 in accordance with teachings found herein.

Determining the geolocation includes determining TDOA and FDOA analyses of the signals, associating a synchronized time with the detected emitter signals and determining the dynamics (the position and velocity) of the baseline vector between the first and second aircraft.

In the foregoing method, the first RWR 201 of the first aircraft is configured as a master and the second aircraft as a slave. The first (master) RWR receives the I/Q (In-Phase/Quadrature) data (solid line in FIG. 2) from a slave RWR, via the datalink 116, and processes this data together with its own I/Q data and determines the emitter geolocation in its controller. In this case, the only I/Q data on the datalink is that from the slave to the master. No emitter geolocation determination would be done in the slave RWR as the slave has not received, in the foregoing example, information from the first RWR. This approach reduces the bandwidth requirements for the datalink between the aircraft.

Referring back to FIG. 3, if the first RWR were to transmit its data, step 310, (dashed line in FIG. 2) onto the network, then the second RWR in the second aircraft 112.2 would have sufficient data to also determine the geolocation of the emitter of interest 104. Thus, multiple RWRs 201 are provided and each is configured as a master to operate redundantly to determine the emitter geolocation in their respective controllers while broadcasting its own I/Q data as well as receiving I/Q data from the other RWRs. Some applications may find the independent and redundant geolocation determinations by each aircraft to be advantageous.

One can also perform multi-ship geolocation with more than two aircraft. As an explanation, let there be N RWRs that are networked together. The number of possible baseline vectors among the N aircraft is

$$\frac{N ( N - 1 )}{2} .$$

In one scenario there can be one master RWR with the other N−1 RWRs as slaves which send their I/Q data to the master. The master can then determine the geolocation solution from a combination of TDOA/FDOA calculations from each of the

$$\frac{N ( N - 1 )}{2}$$

baseline vectors.

In another scenario there can be N master RWRs each one redundantly calculating the geolocation solution from a combination of TDOA/FDOA calculations from each of the

$$\frac{N ( N - 1 )}{2}$$

baseline vectors.

In yet another scenario there can be N RWRs configured so that all

$$\frac{N ( N - 1 )}{2}$$

baseline vectors are calculated but with the computing and datalinking load shared as equally as possible. For example, for three RWRs, each RWR can compute a different baseline vector. With four RWRs, two can each compute two baseline vectors and the two others each computes one baseline vector. With five RWRs, each RWR computes two baseline vectors, etc.

The relatively short baseline vector made possible by this technique enables another configuration using an airplane and a deployed decoy. In this configuration, a small unmanned air vehicle such as a miniature air launched decoy (MALD) is deployed from the airplane. The MALD carries the apparatus of FIG. 5 and flies away from the aircraft to establish the baseline vector. The aircraft and its MALD then carry out the multiship geolocation as described above.

In another scenario, as an example, the RWR on the aircraft equipped with the MALD detects an attacking radar. The aircraft deploys the MALD and together they precisely geolocate the emitter. The MALD is then commanded to either turn on its decoy transmitter or to jam the attacking radar. The aircraft then flies away from the MALD while executing an evasive maneuver and with its precision geolocation launches a missile at the radar.

In another scenario, the aircraft may deploy multiple unmanned air vehicles. This would be advantageous in order to provide a higher accuracy on a geolocation solution, to provide geolocation on multiple targets that are at widely spaced angles from the aircraft, or to set up a network of geolocating sensors reporting back to the aircraft acting as the master.

Thus, operationally, implementations of the present system allow for multiple use cases, for example, including, but not limited to: a) two tactical aircraft flying together and looking for emitters of interest to geolocate, the emitter may be in scan or track mode; b) a single aircraft calling a second one to assist once the first aircraft detects an emitter in scan or track mode and needs to determine the emitter's geolocation; and c) a single aircraft, upon detecting an emitter in scan or track mode, can deploy a maneuverable decoy, e.g., a miniature air-launched decoy (MALD) with RWR capabilities, to assist in geolocating, where, subsequently the decoy (if so equipped) jams the emitter while the aircraft targets the emitter.

The geolocating system of the disclosure was described as being implemented in aircraft—including MALDs, however, the system is not limited to just aircraft. It is understood that other vehicles may be used and the system is not limited to airplanes or other flying vehicles. In an implementation of the present disclosure, one of the two “ships” may be stationary with the other one in motion with respect to it. Further, there may be more than two ships and, in that case, multiple baseline vectors can be calculated providing for more data and, therefore, more accuracy, in determining the emitter's location.

Various implementations of the above-described systems and methods may be implemented in digital electronic circuitry, in computer hardware, firmware, and/or software. The implementation can be as a computer program product (i.e., a computer program tangibly embodied in an information carrier). The implementation can, for example, be in a machine-readable storage device for execution by, or to control the operation of, a data processing apparatus. The implementation can, for example, be a programmable processor, a computer, and/or multiple computers.

While the above-described implementations generally depict a computer implemented system employing at least one processor executing program steps out of at least one memory to obtain the functions herein described, it should be recognized that the presently described methods may be implemented via the use of software, firmware or alternatively, implemented as a dedicated hardware solution such as in an application specific integrated circuit (ASIC) or via any other custom hardware implementation.

It is to be understood that the disclosure has been described using non-limiting detailed descriptions of implementations thereof that are provided by way of example only and are not intended to limit the scope of the claims. Features and/or steps described with respect to one implementation may be used with other implementations and not all implementations have all of the features and/or steps shown in a particular figure or described with respect to one of the implementations. Variations of implementations described will occur to persons of skill in the art.

It should be noted that some of the above described implementations include structure, acts or details of structures and acts that may not be essential and which are described as examples. Structure and/or acts described herein are replaceable by equivalents that perform the same function, even if the structure or acts are different, as known in the art, e.g., the use of multiple dedicated devices to carry out at least some of the functions described as being carried out by the processor of the disclosure.

The present disclosure is illustratively described above in reference to the disclosed implementations. Various modifications and changes may be made to the disclosed implementations by persons skilled in the art without departing from the scope of the present disclosure as defined in the appended claims.

What is claimed is:

1. A method of determining a geolocation of a signal emitter, the method comprising:
detecting, at a first receiver, an emitter signal from the signal emitter;
the first receiver generating first receiver data corresponding to the detected emitter signal;
the first receiver generating first position data corresponding to DGPS signals detected at the first receiver;
receiving, at the first receiver, from a second receiver, second receiver data corresponding to the emitter signal detected at the second receiver and second position data comprising DGPS data detected at the second receiver; and
the first receiver determining the geolocation of the signal emitter as a function of the first and second receiver data and the first and second receiver position data.

2. The method of claim 1, further comprising:
the first receiver transmitting the first receiver data and the first position data to the second receiver; and
the second receiver determining the geolocation of the signal emitter as a function of the first and second receiver data and the first and second position data.

3. The method of claim 1, further comprising the first receiver determining the signal emitter geolocation by employing TDOA and FDOA analyses based on the first and second receiver data and the first and second position data.

4. The method of claim 3, further comprising:
the first receiver determining baseline vector dynamics between the first and second receivers as a function of the first and second position data,
wherein the first receiver determining the signal emitter geolocation is a function of the determined baseline vector dynamics.

5. The method of claim 3, wherein the emitter signal comprises a radar signal.

6. The method of claim 3, further comprising the first receiver:
synchronizing, in frequency and time, the first and second receiver data as a function of a coherent clock signal.

7. The method of claim 6, further comprising providing the coherent clock signal from an atomic clock.

8. The method of claim 3, further comprising the first receiver:
receiving from a third receiver, third receiver data corresponding to the emitter signal detected at the third receiver;
receiving from the third receiver, third position data comprising DGPS data corresponding to the third receiver; and
determining the signal emitter geolocation as a function of the third receiver data and the third position data.

9. The method of claim 8, further comprising the first receiver determining the signal emitter geolocation by employing TDOA and FDOA analyses applied to the first, second and third receiver data and the first, second and third position data.

10. The method of claim 9, further comprising the first receiver:
determining the signal emitter geolocation as a function of two baseline vectors.

11. A method of determining a geolocation of a transmitter of a signal, the method comprising:
detecting the transmitted signal at a first location and generating first detection data corresponding to the transmitted signal detected at the first location;
generating first position data as a function of DGPS signals detected at the first location;
detecting the transmitted signal at a second location and generating second detection data corresponding to the transmitted signal detected at the second location;
generating second position data as a function of DGPS signals detected at the second location; and
determining the geolocation of the transmitter as a function of the first and second detection data and the first and second position data.

12. The method of claim 11, further comprising:
determining a baseline vector between the first and second locations as a function of the first and second position data; and
determining the first transmitter geolocation as a function of the determined baseline vector.

13. The method of claim 11, wherein the transmitted signal comprises a radar signal.

14. The method of claim 12, further comprising:
determining a relative velocity of the second location with respect to the first location as a function of the first and second position data; and
determining the transmitter geolocation as a function of the determined relative velocity.

15. An apparatus for determining a geolocation of a signal emitter, the apparatus comprising:
a DGPS receiver configured to generate first position data corresponding to detected DGPS signals;
a datalink transceiver configured to receive data from other devices on a network;
a first radar warning receiver (RWR) configured to generate first receiver data as a function of an emitter signal detected from the signal emitter; and
a controller, coupled to the DGPS receiver, the datalink transceiver and the first RWR, configured to determine the geolocation of the signal emitter as a function of:
the first position data;
the first receiver data;
second position data corresponding to DGPS signals detected at, and received from, another device on the network; and
second receiver data generated by, and received from, the other device on the network, the second receiver data generated as a function of the emitter signal from the signal emitter detected at the other device on the network.

16. The apparatus of claim 15, wherein the controller is further configured to determine the signal emitter geolocation by employing Time Difference of Arrival (TDOA) and Frequency Difference of Arrival (FDOA) analyses applied to the first and second receiver data and the first and second position data.

17. The apparatus of claim 16, wherein the controller is further configured to:
determine a baseline vector as a function of the first and second position data; and
determine the signal emitter geolocation as a function of the determined baseline vector.
